(19) United States
(12) Patent Application Publication
(10) Pub. No.: US 2014/0149281 A1
(43) Pub. Date: May 29, 2014

(54) SIGN INTERFACE CONTROL WITH OPTIONAL PAYMENT

(71) Applicant: RAWLLIN INTERNATIONAL INC., Tortola (VG)

(72) Inventors: Simon Shvarts, San Jose, CA (US); Rodion Shishkov, St. Petersburg (RU)

(73) Assignee: Rawllin International Inc., Tortola (VG)

(21) Appl. No.: 13/688,825

(22) Filed: Nov. 29, 2012

(51) Int. Cl. G06Q 50/18

(52) U.S. Cl. CPC G06Q 50/18
USPC 705/39; 705/311

(57) ABSTRACT

An interface control is activated to provide a signature to a legal document, an application for a contractual obligation or other document requesting legal signature, in conjunction with an optional payment mechanism. The interface control initiates facilitation of signing of the document or application, and optionally enables payment for the document, application or associated product or service. A client signature generated from a client with a client device and purchasing data of the client are provided in a transaction in response to activation of the interface control.

### TECHNICAL FIELD

The subject application relates to transactional exchanges and operations related to signature and optionally, payment in addition to signature.

### BACKGROUND

Legal and technical challenges exist with respect to protection of customer information, increasing incidents of fraud in banking sectors such as identity theft, and the introduction of authentication technologies. Banks are recommended to conduct risk-based assessments, evaluate customer awareness programs, and develop security measures to reliably authenticate customers remotely accessing their internet-based financial services.

Agencies consider single-factor authentication, as the only control mechanism, to be inadequate for high-risk transactions involving access to customer information or the movement of funds to other parties. Financial institutions offering Internet-based products and services to their customers are recommended to use effective methods to authenticate the identity of customers using those products and services. The authentication techniques employed by the financial institution should be appropriate to the risks associated with those products and services. Account fraud and identity theft are frequently the result of single-factor (e.g., ID/password) authentication exploitation. Where risk assessments indicate that the use of single-factor authentication is inadequate, financial institutions are recommended to implement multi-factor authentication, layered security, or other controls reasonably calculated to mitigate those risks.

With the growth in electronic banking and commerce, financial institutions are recommended to use reliable methods of originating new customer accounts online. Moreover, customer identity verification during account origination is required by some law and is important in reducing the risk of identity theft, fraudulent account applications, and unenforceable account agreements or transactions. Potentially significant risks arise when a financial institution accepts new customers through the Internet or other electronic channels.

The above-described challenges of today's banking sectors lend for the need to better serve clients by providing better authentication security for the clients and devices, in which the client transacts with. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for a system to execute an online application and/or transaction are contained herein. An exemplary system comprises a memory that stores computer-executable components, and a processor, communicatively coupled to the memory, that facilitates execution of the computer-executable components. The computer-executable components can include a server component communicatively coupled to a data store that stores a set of electronic signatures, and is configured to manage the set of electronic signatures in connection with a legal document or an online application in an approval process of a contractual obligation. An interface control component is configured to generate an interface control and communicate the interface control to a client application from which the legal document or the online application is to be signed. A signature component configured to, in response to an activation of the interface control and based on an identity represented by the activated interface control, retrieve an electronic signature of the set of electronic signatures, and to sign the legal document or the online application with the electronic signature via the client application.

In another non-limiting embodiment, an exemplary apparatus comprises a memory storing computer-executable instructions, and a processor, communicatively coupled to the memory. The processor facilitates execution of the computer-executable instructions to at least: communicate an electronic signature in response to receiving an activation of an interface control to a legal document, or an online application in an approval process of a contractual obligation, and communicate a payment from a client account in response to the activation of the interface control.

In yet another non-limiting embodiment, an exemplary method includes receiving, by a server component including at least one processor, a set of electronic signatures in connection with a legal document or an online application in an approval process of a contractual obligation. The method includes generating an interface control to a client application from which the legal document or the online application is to be signed. An electronic signature is communicated from the set of electronic signatures in response to receiving an activation of the interface control.

In still another non-limiting embodiment, an exemplary computer readable storage medium comprising computer executable instructions that, in response to execution, cause a computing system including at least one processor to perform operations. The operations comprise receiving, by a server component, an activation input of an interface control. The operations include communicating an electronic signature to a legal document or an online application for approval for a contractual obligation. The electronic signature corresponds to a unique identity and is created by a set of modification control inputs.

In another non-limiting embodiment, a system is disclosed having a means for creating an electronic signature by a set of modification control inputs received via a client application; means for receiving an activation input from an interface control via the client application; and means for communicating the electronic signature to a legal document or an online application for approval for a contractual obligation.

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system in accordance with various aspects described herein;

FIG. 2 illustrates another example system in accordance with various aspects described herein;

FIG. 3 illustrates another example system in accordance with various aspects described herein;

FIG. 4 illustrates another example system in accordance with various aspects described herein;

FIG. 5 illustrates an example view pane in accordance with various aspects described herein;

FIG. 6 illustrates another example view pane in accordance with various aspects described herein;

FIG. 7 illustrates another example view pane in accordance with various aspects described herein;

FIG. 8 illustrates an example of flow diagram in accordance with various aspects described herein;

FIG. 9 illustrates another example of a flow diagram in accordance with various aspects described herein;

FIG. 10 is a block diagram representing exemplary non-limiting networked environments in which various non-limiting embodiments described herein can be implemented; and

FIG. 11 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

### OVERVIEW

In consideration of the above-described deficiencies among other things, various embodiments are provided for generating a signature, and further integrating payment processes in a transaction, such as with an online application or a legally binding document, which requires a signature. For example, a system manages a data base having a set (one or more) of electronic signatures, as well as purchasing data or payment data for a client. The system further operates to communicate the signature and payment data to a third party via a network (e.g., a Wide Area Network (WAN), a Local Area Network (LAN), a Cloud network and/or other such networks) and/or a wired connection. The system, having authenticated and verified the client or client device, can communicate the signature to a third party in response to an activation of an interface control. Additionally, the system can also communicate payment data to the third party in response to the activation of the interface control (e.g., a sign button, or a sign and pay button, or the like). The server component communicates, via the wireless or wired connection, with a client device, and/or other servers or third party host servers to provide an integrated and simplified approach to completing transactions with a signature from a client of a client device. The electronic signature, for example, is provided in connection with transactions involving documents such as legal documents, online applications and other documents that include a client signature. Payment can also be included with the electronic signature in order to provide a seamless transaction with the interface control.

In one embodiment, the interface control is generated to receive an activation input in order to facilitate an electronic signature in connection with a legal document or online application. Additionally, a payment is also provided in response to the activation input so that an integrated online experience is possible by supplying an electronic signature that is accepted at various institutions and a payment process with a single input control, such as a sign and pay button.

Sign Interface Control with Optional Payment

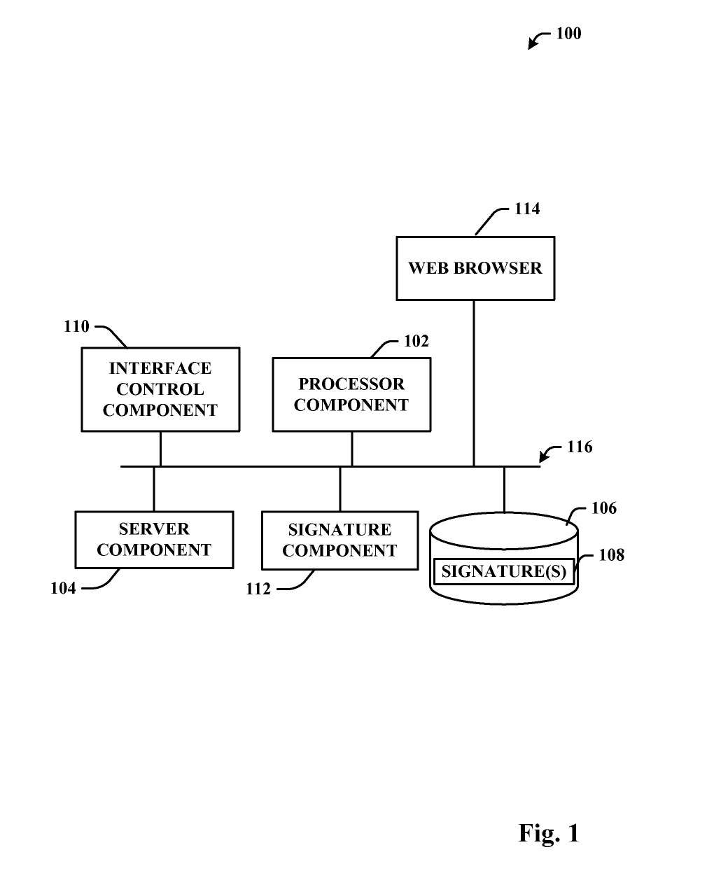

Referring initially to FIG. 1, illustrated is an example system 100 that enables a transaction with a third party requesting a legal signature, and payment in accordance with various embodiments described. A sample of such transactions include bank operations data related to any number of banking activities or products such as transactions for legally binding documents or online applications with checking accounts, savings accounts, money market accounts, Certificate of Deposits (CD's), Individual Retirement Accounts (IRA's), credit cards, debits cards, mortgages, home equity loans, mutual funds, personal loans, business loans, capital raising, mezzanine finance, project finance, revolving credit, risk management, term loans, cash management servers, and the like. The system 100 can include an authentication/verification system that enables transactions related to legal documents or online applications requiring a signature and payment. The system 100 manages the authentication/verification processes for a third party and the client device, and further enables a seamless transaction with the client or client device by generating the client's electronic signature as well as an additional payment for transaction with the third party. The transaction can be conducted with the client via a client device, such as a mobile device or other device from a remote location, in which details are further described below.

The system 100 comprises a server component 104, a data store 106 for storing instructions that are executed via a processor component 102. The system 100 includes an interface control component 110 and a signature component 112. The system 100 and components illustrated can be configured in a number of other ways and may include other or different elements. For example, a server component 102 can include one or more output devices, modulators, demodulators, encoders, decoders for processing data and/or like components.

Interface control component 110 generates an interface control that initiates a communication of an electronic signature from the set of electronic signatures 108. The interface control, for example, can comprise a graphical user interface control such as a button, and/or other similar interface control that enables a user or client to interface with one or more devices, third party servers, and/or networked vendors. The interface control component 110 facilitates triggering an activation of the interface control in order to initiate the server component 104 with the signature component 112 to process a transaction with an electronic signature corresponding to an identified client. The interface control 110, for example, can comprise a graphical user interface control that simulates an actual signature of an offline user, such as via a button, and/or other similar interface control, which can function with a biometric ID fingerprint, electronic signature pad, touch pad, fingerprint pad, etc., that enables a user or client to interface with one or more devices, third party servers, and/or networked vendors.

The signature component 112 communicates the electronic signature associated with a verified user and/or a client device of the user. For example, a client selects a product to purchase that involves a legal signature, which can be provided, for example, in connection with an online application, a legal document or other such instrument in an exchange involving legal signature with payment. At a single interface control generated by the interface control component 110, the user can provide a single input, such as a single touch input or a single click input to facilitate signature of the legal document or online document via a network connection. The signature component 112 thus communicates the client's electronic signature and signs the legal document or the online application with the electronic signature from the set of electronic signatures 108 in response to an activation of the interface control via the web browser 118.

A bus 116 permits communication among the components of the system 100. The processor component 102 includes processing logic that may include a microprocessor or application specific integrated circuit (ASIC), a field programmable gate array (FPGA), or the like. The processor 102 can also include a graphical processor (not shown) for processing instructions, programs or data structures for displaying a graphic, such as a three-dimensional scene or perspective view.

The data store 106 may include a random access memory (RAM) or another type of dynamic storage device that stores information and instructions for execution by the processor 106, read only memory (ROM) or another type of static storage device that may store static information and instructions for use by processing logic, a flash memory (e.g., an electrically erasable programmable read only memory (EEPROM)) device for storing information and instructions, and/or some other type of magnetic or optical recording medium and its corresponding drive. The data store 104 includes a set of electronic signatures 105 that is related to one or more clients for use with a legal document and is maintained by the server component 104 according to customary banking regulations/operations.

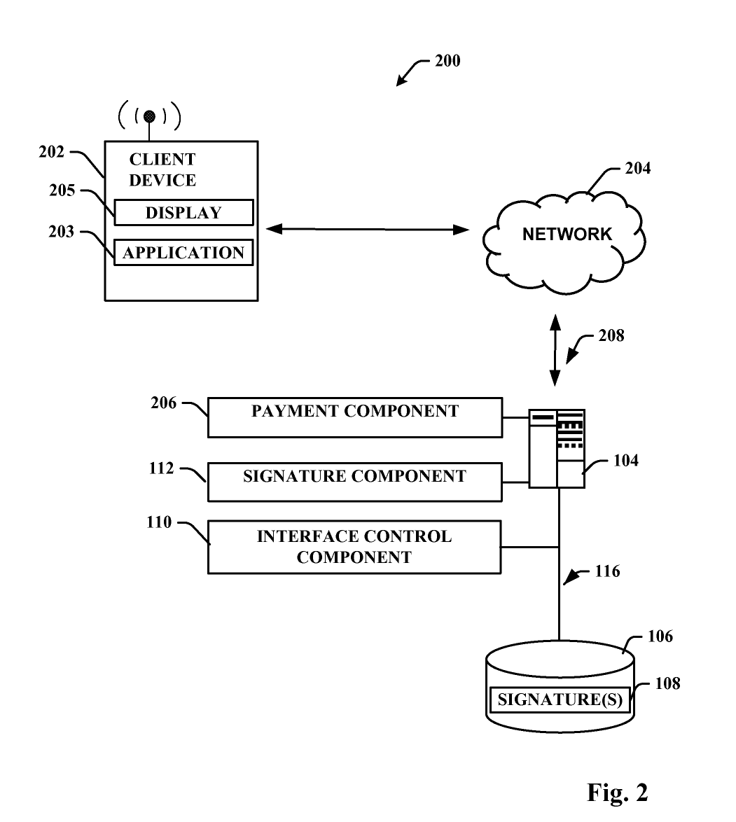

Referring now to FIG. 2, illustrated is an exemplary system 200 that electronically signs legal documents or online applications involving a legal signature, such as a contract or other obligatory agreement. The system 200 includes components that are similar to components discussed above in FIG. 1, and further includes a payment component 206 to instantiate payments to a vendor, third party and/or other party to a transaction in conjunction to the signing of one or more documents via the signature component 112.

The interface control generated by the interface control component 110 can enable one or more mechanisms that permit a user to input information to the server 102, such as microphone, keypad, control buttons, a keyboard, a gesture-based device, an optical character recognition (OCR) based device, a joy-stick, a virtual keyboard, a speech-to-text engine, a mouse, a pen, voice recognition, biometric mechanisms, etc. for conducting operations or banking transactions with the server component 104 with financial accounts stored on the data store 104. The server component 104 is operable as a third party server, or as a separate server component 104 that manages the electronic signatures 108 of the data base 106 via a network 204 and a network connection 208. In addition or alternatively, the server component 104 and components operably connected thereto can operate on a client device to manage a signature (e.g., a hand-written digital ink signature, a digital stylus signature, a gesture signature, and the like) and payment data for an online transaction.

The payment component 206 is configured to process a payment in response to the activation of an interface control (e.g., a button, or other interface control) generated in a client application 203 (e.g., a web browser, or other application) of a client device 202. The payment component 206 communicates payment data or purchase data for generation of a payment in response to the activation of the interface control, which is generated by the interface control component 110. For example, the server component 104 can receive the activation of the interface control as a trigger to the payment component 206 and the signature component 112, in order to generate a signature and payment concurrently, at about the same time, simultaneously, or in conjunction based on the same activation and the same interface control.

In one embodiment, the interface control component 110 generates the interface control on the client device 202, on a third party application at a third party server or host system, via a cloud resource on the network 204, through a different hosting system/device for the third party server/application and/or the client device 202. The interface control component 110 provides a trigger mechanism to initiate the payment component 206 and the signature component 112 via a single trigger mechanism (interface control).

In one example, the client device 202 can operate to generate the interface control (e.g., a sign and pay button) in a display 205. A user can trigger the interface control with the device 202, which can already be authenticated and/or verified via the server component 206 prior to any attempt at a transaction involving the legal signature and payment data. A legal signature can be a mark, sign or the like by an individual (client) on an instrument or document to signify knowledge, approval, acceptance and/or obligation. A signature or legal signature is understood to mean the signing of a written document with one's own hand. However, the signature does not need to be handwritten, and can be typewritten, created, and/or generated to authenticate a writing, provide notice of its source, and to bind the individual signing or creating the signature to provisions contained within a document. Therefore, digital signatures are also included in what is termed as a signature or legal signature. When an instrument (e.g., a legal document or online application for approval of a contractual obligation) requires/invokes a signature, it is often adequate that the signature is made in any commonly used manner.

The system 200 can utilize a network 204 such as a Wide Area Network (WAN), (Internet), a Cloud network, a Local Area Network (LAN) and/or other forms of telecommunication, for example, to fulfill needs to transact legally binding agreements electronically with a legal signature (e.g., an electronic or digital signature) and payment in conjunction. For example, when an instrument must be signed, it is ordinarily adequate if the signature is made in any commonly used manner. Variations between the signature and the name appearing in the body of the instrument do not automatically invalidate the instrument. In the absence of a statutory prohibition, an individual can use any character, symbol, figure, or designation that the user wishes to adopt as a signature, and if the user uses the signature as a substitute for his name, the user is bound by it. For example, if a contract refers to “William Jones” but Jones signs his name “Bill Jones,” the contract is still enforceable against him. An individual can also use a fictitious name or the name of a business firm. A signature might also be adequate to validate an instrument even if it is virtually illegible or symbolic. The entire name does not have to be written, and the inclusion of a middle name is not significant. In situations that do not require a more complete signature, an instrument can be properly signed when the initial letter or letters of the given name or names are used together with the surname (J. Doe), when only the full surname is used (Doe), when only the given name is used (John), or even when only the initials are used (J. D.). A mark is ordinarily a cross or X made in substitution for the signature of an individual who is unable to write. In the absence of contrary statutory provision, a mark can be used by an individual who knows how to write but is unable to do so because of a physical illness or disability. A mark has the same binding effect upon the individual making it as does a signature. In some statutes a signature is defined as including a mark made by an individual who is infirm or illiterate. A signature can generally be made by one individual for another in his presence and at his direction, or with his assent, unless prohibited by statute. A signature that is made in this manner is valid, and the individual writing the name is regarded merely as an instrument through which the party whose signature is written exercises personal discretion and acts for himself. A signature can be affixed in a number of different ways. For example, it can be hand written, printed, stamped, typewritten, engraved, or photographed, which allows, for example, a business to issue its payroll checks with the signature of its financial officer stamped rather than handwritten.

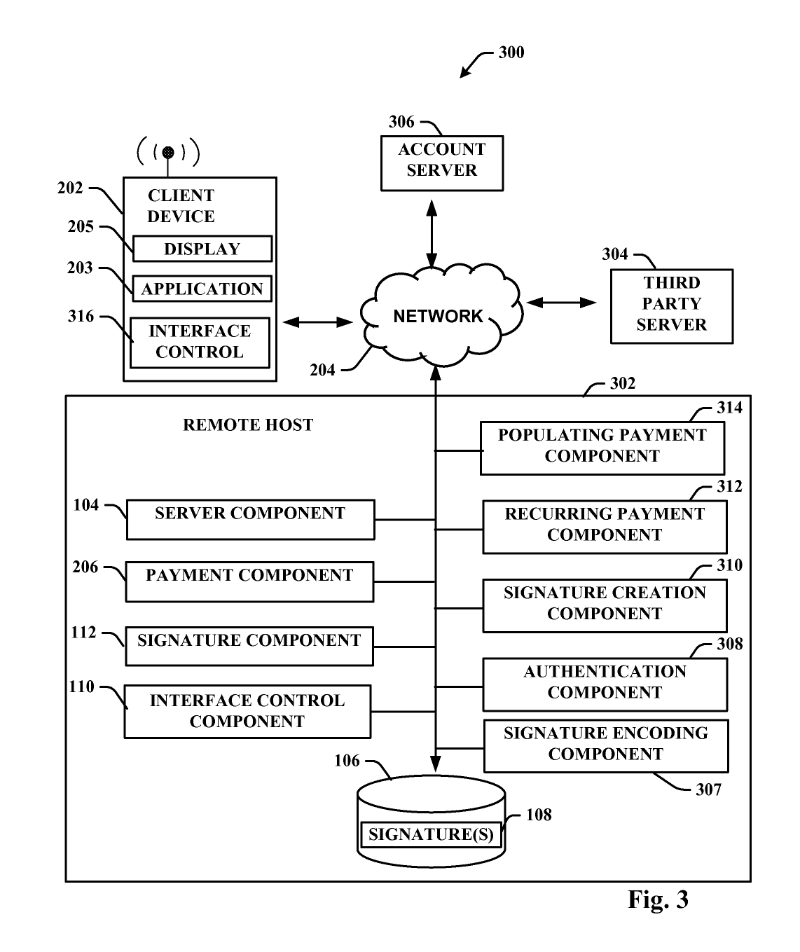

Referring now to FIG. 3, illustrates another example system 300 in accordance with various embodiments described. The system includes similar components as discussed herein, and further includes a remote host 302 that can include a computing device, and/or any other device for processing executable instructions for components in communication with the remote host 302. The remote host 302 can operate to communicate with the server component 102, the payment component 206, the signature component 112, the interface control component 110 and the data store 106. A client is able to register with the remote host 302 and/or like components on the client device 202 so that an interface control 316 is generated with the device 202 via an application 203 and/or in the display 205.

The remote host 302 can further provide executable instructions to be processed in an application 203 via the network 204, in which resources (hardware and/or software) of the network can be communicated to the client device and/or a third party device/server 304, such as with a cloud infrastructure, in which computing infrastructure, a computing platform, software, storage, security, data, test environment, desktop, an application programming interface (API) and the like can be provided. In one example, the interface control component 110 operates to provide the interface control 316 via the network 204 to the client device 316. The interface control 316 could also be provided to the third party server 304. In response to an activation of the interface control 316 (e.g. a sign and pay button, or the like graphical user control), the signature component 112 and the payment component 206 generate a legal signature and a payment respectively to provide an integrated digital purchase involving instruments invoking a signature and a payment for a transaction. The remote host 302 can include an authentication component 308, a signature creation component 310, a recurring payment component 312, and a populating component 314 that are communicatively coupled.

The authentication component 308 enables an authentication of a client or user of the client device 202. For example, the authentication component 308 can operate to authenticate a user such as with a digital signature, which is intended as different from the legal signature or signature provided by the signature component 112. For example, the digital signature utilized by the authentication component can be based on cryptography, which uses mathematical formulas, or algorithms, to scramble messages. Using encryption and decryption software, the authentication component 308 can scramble any communication message and the recipient can unscramble it. To affix a digital signature to an electronic communication or document, a signer obtains electronic “keys,” such as a private key, a public key and/or any other authentication processes. For example, a pre-registered user with a qualified or verified signature at the system 300 can sign a document at a signature pad, such as with a stylus, touch screen and/or gesture. The system 300 can then recognize whether the signature is the correct signature, such as by mapping the received signature with a matching signature stored on a database as the user's signature and assign the received signature to a digital signature for signing a legal document with the signature received.

In one example, the authentication component 308 in communication with the signature component 112 can provide the signature that is matched with a digital signature for office signing of legal documents, for example, escrow documents, etc., in which a pre-registered user has a qualified signature with a verification center, such as with system 300 connected with a verification mechanism, such as the authentication component 308. Additionally or alternatively, the user can be registered with the current system 300 and have a universally unqualified signature that is a verified by the authentication component 308.

The authentication component 308 can include algorithms, state based tables, and the like for generating factors that operate to indicate each remote device as authenticated for interfacing with the server component 104 and the data store 106. In one example, the authentication component 308 can receive the electronic signature via different alternative authentication methods, such as with a user identification (ID) and password, via the use of a biometric ID or stylus entered signature pad, which allows system to identify the user, authenticate and select appropriate digital signature to be associated with the signed document. The third party server 304, for example, can thus conduct transactions for various financial instruments (e.g., a legal document and/or online application) for obligations without having to conduct their own security over the network. The remote host 302 provides the authentication and verification processes with the client device 202 for operation of the interface control 316 for the third party, which can chose to participate in the services of the remote host 302.

The populating component 314 is configured to populate a transaction field of a networked application, which can be hosted by the third party server 304 or some other remote host, for example. Payment data or purchasing data (e.g., checking data, account data, account numbers, etc.) including personal data (e.g., name, address, contact info, etc.) that is related to the transaction can be populated in a corresponding field by the populating component 314. The populating component 314, for example, can populate payment data or transaction fields in response to activation of the interface control 316. Alternatively or additionally, an online application field or a legal document field of the networked application at a remote host can be populated with the legal signature in response to the activation of the interface control. The populating component 314 can also populate an additional data field together with or separately to populating the payment data (e.g., account numbers, checking info, etc.), as well as populating the signature fields with data from the signature component 112. Information or data further populated in the additional data field can include any data needed for the transaction or obligation such as personal data, contact info, etc., for example.

The recurring payment component 312 is configured to generate a recurring payment in connection with the transaction invoking a legal signature. The recurring payment component 312 can operate according to user preferences or with the requirements of the transaction that the client device 202 is initiating with the activation of the user interface control 316. For example, a loan program could request monthly payments to be set according to an automatic monthly withdrawal or transfer, and the recurring payment component 312 can respond to the activation (e.g., a single click, single touch, single input, etc.) of the interface control 316 by facilitating or initiating such recurring payment or a subscription billing with the third party server 304 and the client account held or maintained with an account server 306 or other managed accounting system. The server component 104 can communicate purchasing data to the account server for a transmission of funds from a set of client accounts, in response to the activation of the interface control at the client application 203.

The signature creation component 310 is configured to create the electronic signature, store the electronic signature in the data store and edit the electronic signature according to a set of modification controls. The signature creation component 310 operates to enable a client with a client device and/or other device to create and store a legal signature 108. The signature can be a hand-written digital ink signature, a stylus created signature, a touch screen input, a faxed signature, and/or any other generated signature accepted by the client as their legal mark or signature for use by the signature component 112. The signature creation component 310 then communicates the created signature to the signature creation component 112 and/or stores the signature in a data base in association with the client and/or client device identification.

The signature creation component 310 is communicatively coupled to a signature encoding component 307 that can operate to present the signature as an encoded signature, with special watermarks, as a watermark image, stamp type graphics, and/or on a digital display with special header graphics or wording. In one embodiment, a symbol can be generated to display with the signature indicating a secure signature, such as a lock or other graphical symbol for indication of an encrypted document to prevent changes and a signed document with a digital signature. In addition or alternatively, the signature encoding component 307 can operate to differentiate signed documents from not signed documents by using a filter or set of processes that differentiates among a set of documents. For example, an escrow officer reviewing documents signed by parties can operate the signature encoding component 307 to filter signed documents only and have the signed documents presented for viewing only those documents that have been prepared as closing transaction documents and for final review or approval.

Modification of the signature is further enabled by modification controls that can include at least one of an alteration control that alters a background appearance of the electronic signature based on reception of an alteration input, a combination control that combines the electronic signature stored with an additional digital mark, a time stamp control that time stamps the electronic signature in response to a retrieval of the electronic signature from the data store, a color control that selects a color for the electronic signature and/or a visibility control that selects a degree to which the electronic signature is visible, as well as other modification controls to manipulated, edit, and/or modify the signature by which a user associates their legal obligated for a legal instrument such as a legal document and/or an application for approval of an obligation.

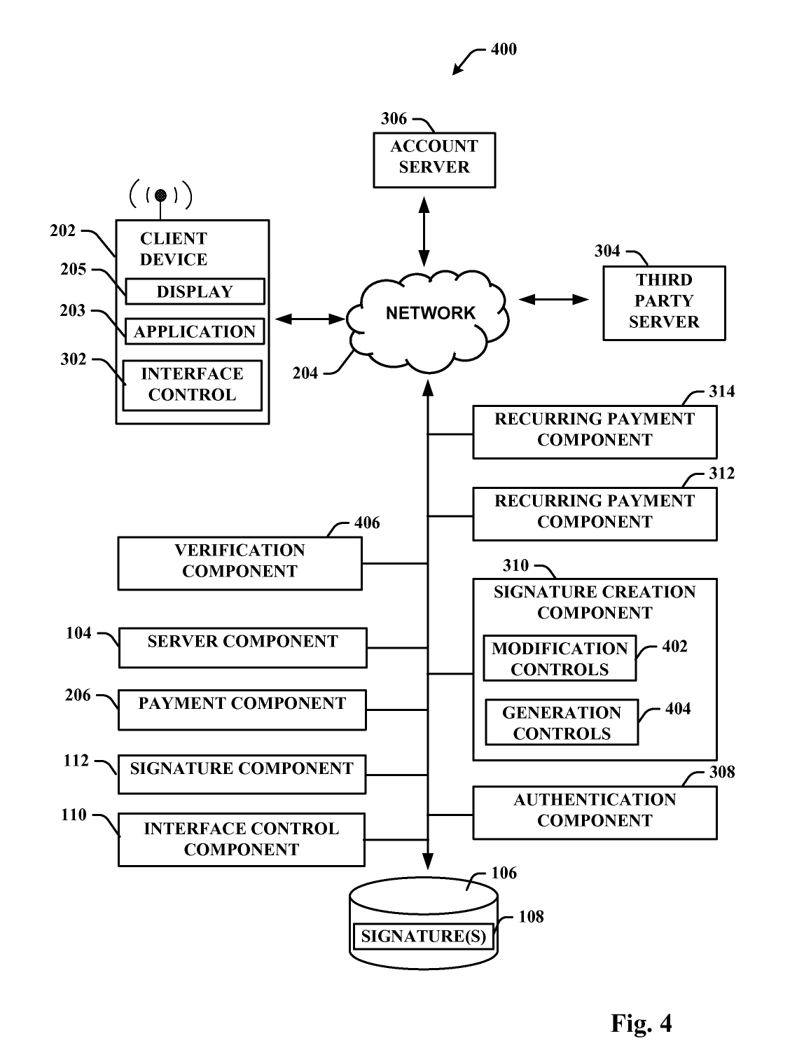

Referring to FIG. 4, illustrates an example of the signature component 310 having a set of modification controls 402 and a set of generation controls 404. For example, graphical user interface controls can enable the generation and/or modification of a signature in connection with a client and/or user client device. In addition or alternatively, the client or user that is going to be involved in a transaction for an instrument such as a legal document or online application involving a signature and a payment can provide their digital signature from the device 202 and/or another device. An application provided to the user with the generation controls 404 to the client device can also enable creation of the signature in accordance with protocols generated at a remote host, and/or the third party server 304, for example. The signature can also be generated with various formats, such as by a color selection, background, font, size, etc., as well as any symbols that a user can deem appropriate. The modification controls 402 can include an alteration control that alters a background appearance of the electronic signature based on reception of an alteration input. The modification controls 402 can enable a user to modify a signature once it has been created. For example, a combination control included in the modification controls 402 can combine the electronic signature stored with an additional digital mark. Additionally, a time stamp control can provide time stamps the electronic signature in response to a retrieval of the electronic signature from the data store. A color control can select a color (e.g., red, black, blue) for the electronic signature and/or a visibility control can select a degree to which the electronic signature is visible. The modification controls 402 can further include other modification controls to manipulate, edit, and/or modify the signature by which a user associates their legal obligated for a legal instrument such as a legal document and/or an application for approval of contractual obligation.

The system 400 further includes a verification component 406 that is configured to verify a client or user via a client device, on a remote host, or over the network 204. Verification can include any number of processes in conjunction with the authentication component 308 to authenticate and verify the client device 202. For example, via telephone, digital signature, text, two way authentication and/or the like processes, the client's identification can be authenticated and verified for enabling utilization of the interface control 302, for example.

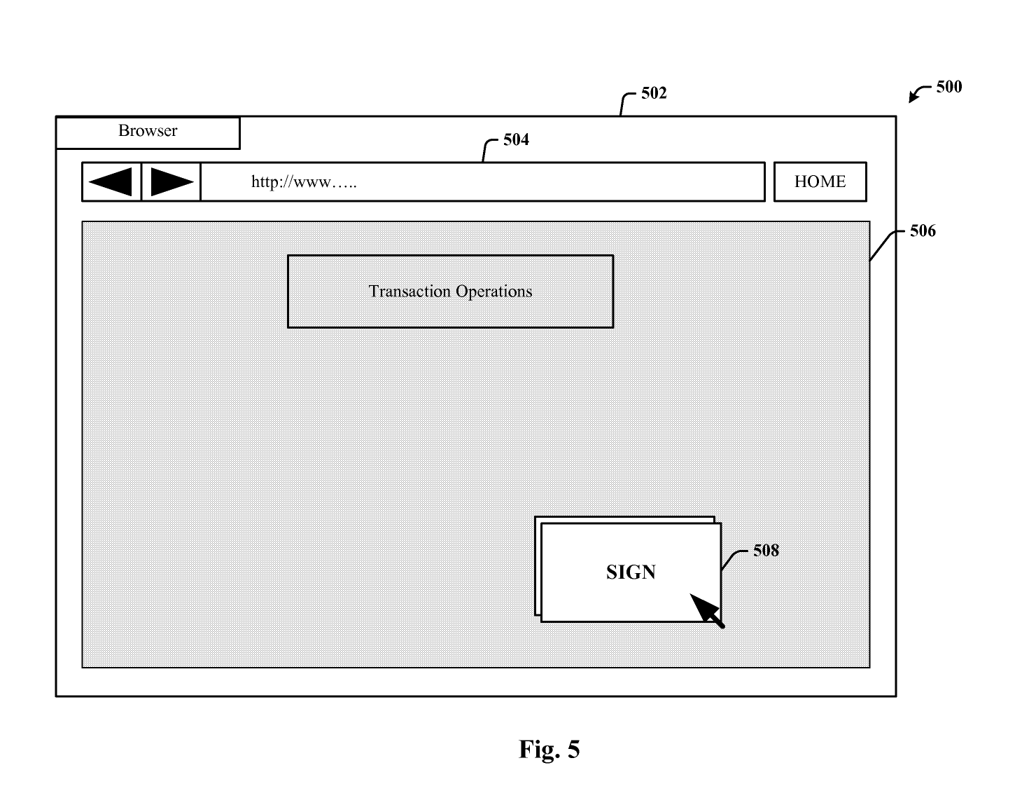

Referring now to FIG. 5, is an example input viewing pane/screen 502 in accordance with various aspects described herein. A viewing pane 500 is an example view pane that can be rendered in a client device, such as a mobile device, at a website or webpage of a third party host and/or from another third party. As discussed previously, the viewing pane 500 can be associated with a web browser with a financial database hosted on a banking server. The viewing screen 500 may be a GUI generated by utilizing any one of a number of other technologies, such as Asynchronous, JavaScript and XML, Adobe FLASH and the like. Banking functions for financial transactions on a banking web page 506 and/or another webpage involving a transaction with an instrument (e.g., a financial instrument, legal document, application, etc.) invoking or calling for a legal and/or electronic signature can be accessed via a web browser 502 that can include an address bar 504 (e.g., URL bar, location bar, etc.). The web browser 502 can expose an initiation mechanism such as an interface control 508 to initiate or facilitate a communication of a legal signature.

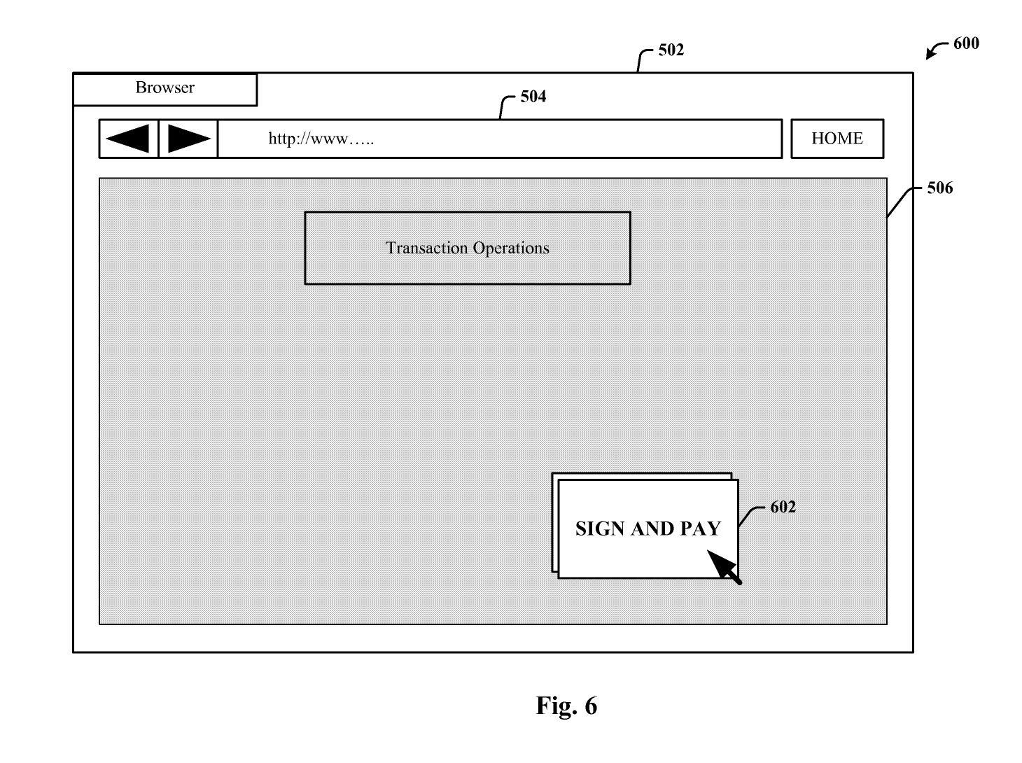

Referring to FIG. 6, illustrated is an example input view screen a described above with regard to the viewing pane 500 and in accordance with various aspects described in this disclosure. The web browser 502 can expose an initiation mechanism such as an interface control 602 to initiate or facilitate a communication of a legal signature and payment information for processing a payment in conjunction therewith. Therefore, an activation of the sign and pay interface control 602 facilitates communication of both the legal signature and payment processing in a transaction, in accordance with embodiments described herein.

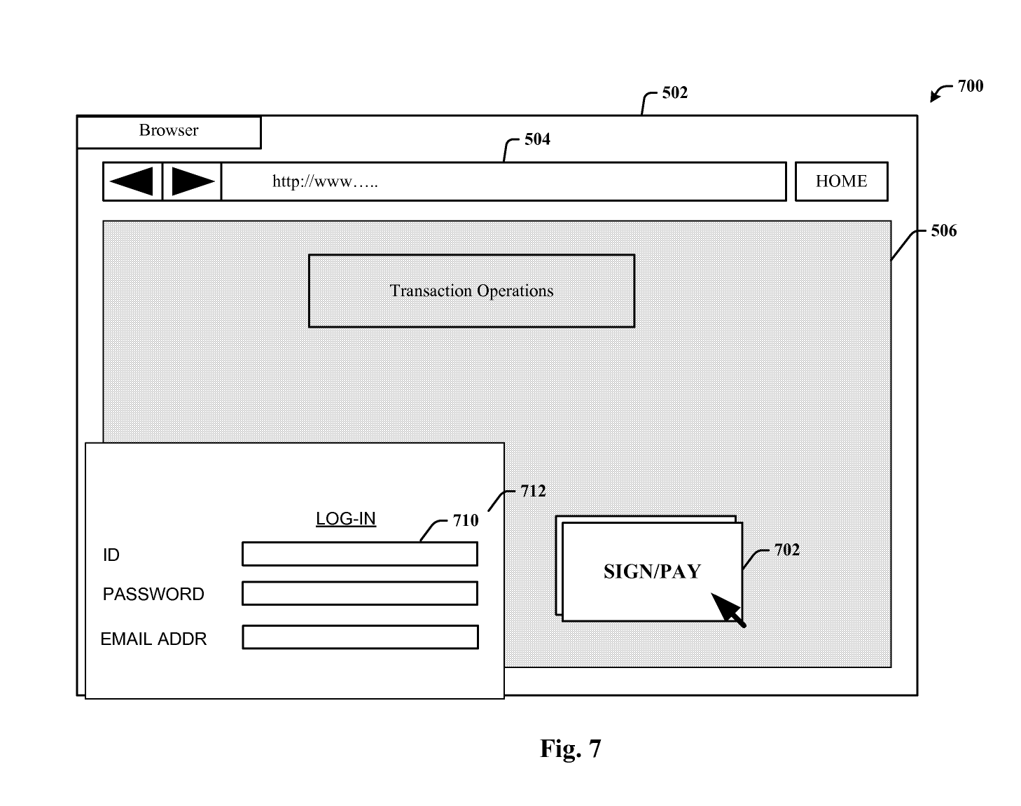

Referring now to FIG. 7, illustrated is an example input viewing log-in screen 600 in accordance with various aspects described herein. Similar components and references are referred to as in FIGS. 5 and 6. The log-in screen 712 is on example of authentication and verification processes that can be employed to ensure the interface control (e.g., sign and pay button) for the particular user and/or client devices is the principle or agent for utilizing the signature and payment data. In one embodiment, this can be a service provided by a remote host and/or resources via a network (e.g., a cloud network), which can, in one example, include log-in fields 710 (e.g., ID field, password field, email address and/or the like) as part of and/or in addition to a complete, multifactor authentication/verification process being provided and secured with the client.

While the methods or process flows described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

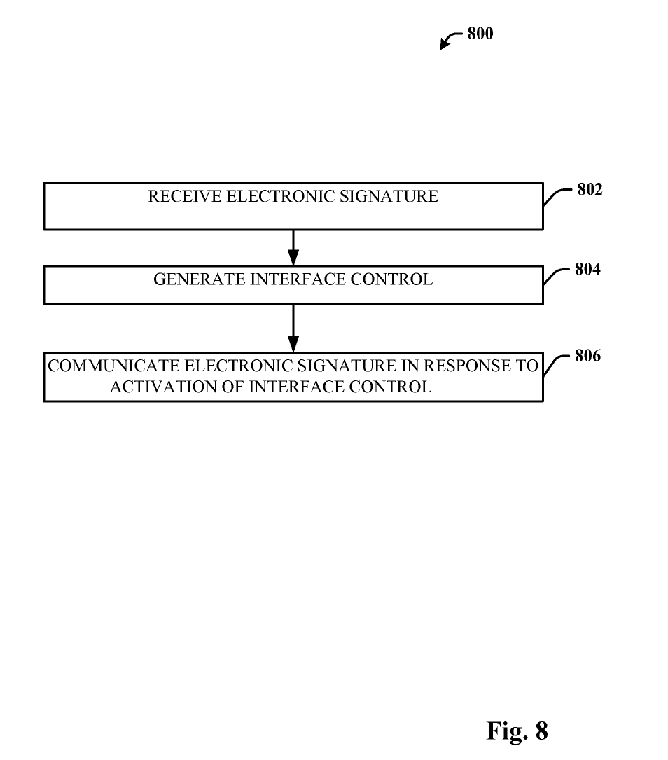

An example methodology 800 for implementing a method for a system that provides an integrated online experience with a smart card reader component is illustrated in FIG. 8. Reference is made to the figures described above for ease of description. However, the method 800 is not limited to any particular embodiment or example provided within this disclosure.

FIG. 8 illustrates the exemplary method 800 for a system in accordance with aspects described herein. The method 800, for example, provides for a system to communicate data to a network device for payment, identification, authentication and/or signature to a transaction.

At 802, an electronic signature is received in connection with a legal document, an online application, and/or other instrument for approval in a contractual obligation. The signature is a generated signature such as a legal signature or electronic signature that binds a person to a transaction or evidences an understanding and/or approval of the transaction. An interface control (e.g., a sign and pay button) is generated for activation in a client application such as a web browser and/or other application. At 806, the electronic signature is communicated in response to activation of the interface control.

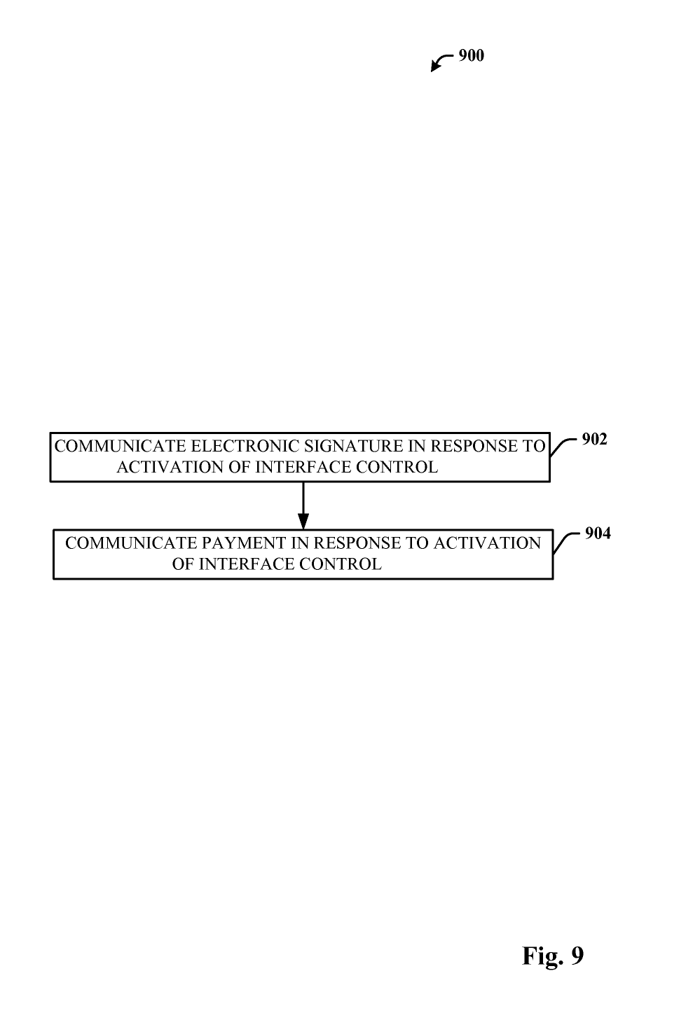

An example methodology 900 for implementing a method for a system to process an online application or transaction is illustrated in FIG. 9. Reference may be made to the figures described above for ease of description. However, the method is not limited to any particular embodiment or example provided within this disclosure.

The method 900, for example, provides for a system to process an online application and/or transaction for goods or services. At 902, an electronic signature (legal signature) is communicated in response to activation of an interface control as discussed herein. At 904, payment is also communicated in conjunction with activation of the interface control.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

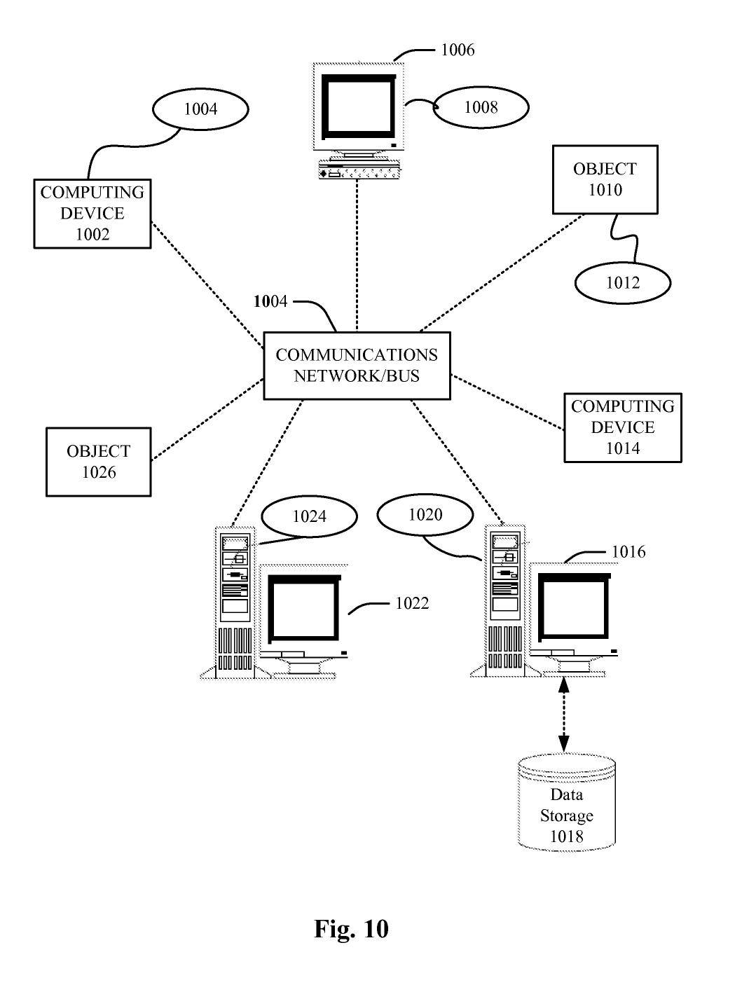

FIG. 10 provides a schematic diagram of an exemplary networked or distributed computing environment. The distributed computing environment comprises computing objects 1010, 1026, etc. and computing objects or devices 1002, 1006, 1010, 1014, etc., which may include programs, methods, data stores, programmable logic, etc., as represented by applications 1004, 1008, 1012, 1020, 1024. It can be appreciated that computing objects 1012, 1026, etc. and computing objects or devices 1002, 1006, 1010, 1014, etc. may comprise different devices, such as personal digital assistants (PDAs), audio/video devices, mobile phones, MP3 players, personal computers, laptops, etc.

Each computing object 1010, 1012, etc. and computing objects or devices 1020, 1022, 1024, 1026, etc. can communicate with one or more other computing objects 1010, 1012, etc. and computing objects or devices 1020, 1022, 1024, 1026, etc. by way of the communications network 1028, either directly or indirectly. Even though illustrated as a single element in FIG. 10, communications network 1028 may comprise other computing objects and computing devices that provide services to the system of FIG. 10, and/or may represent multiple interconnected networks, which are not shown. Each computing object 1010, 1026, etc. or computing object or device 1020, 1022, 1024, 1026, etc. can also contain an application, such as applications 1004, 1008, 1012, 1020, 1024, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, etc. can be thought of as clients and computing objects 1010, 1026, etc. can be thought of as servers where computing objects 1010, 1026, etc., acting as servers provide data services, such as receiving data from client computing objects or devices 1020, 1022, 1024, 1026, etc., storing of data, processing of data, transmitting data to client computing objects or devices 1020, 1022, 1024, 1026, 1028, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1040 or bus is the Internet, for example, the computing objects 1010, 1026, etc. can be Web servers with which other computing objects or devices 1020, 1022, 1024, 1026, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, etc., as may be characteristic of a distributed computing environment.

### Exemplary Computing Device

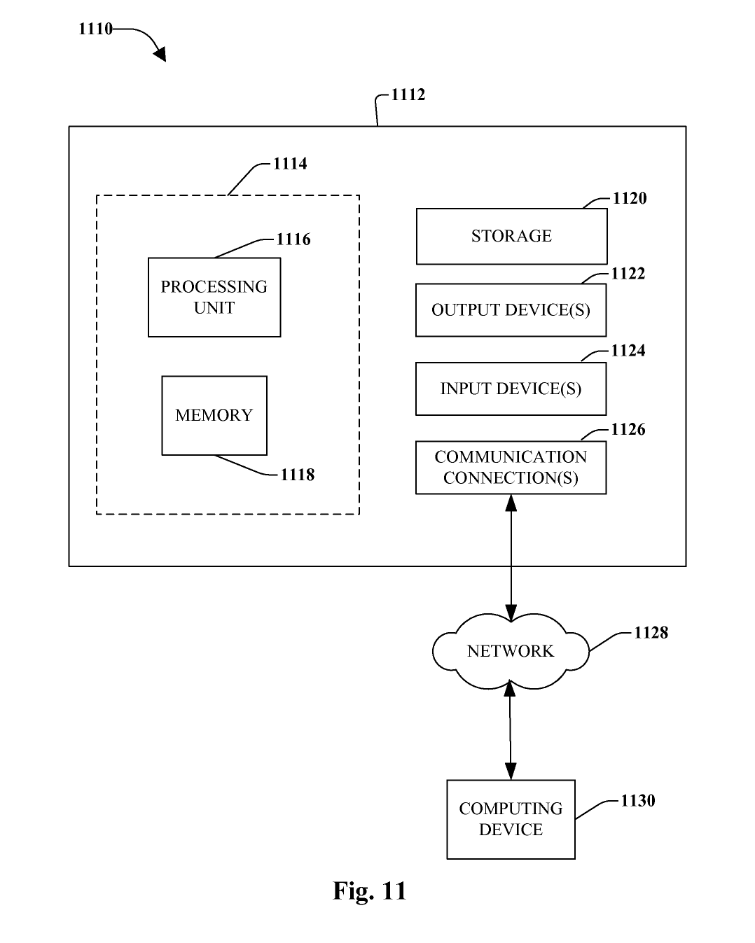

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 11 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 11 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1118 and storage 1120 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer readable storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system, comprising:
a memory that stores computer-executable components, and a processor, communicatively coupled to the memory, that facilitates execution of the computer-executable components, the computer-executable components including:
a server component communicatively coupled to a data store that stores a set of electronic signatures, and is configured to manage the set of electronic signatures in connection with a legal document or an online application in an approval process of a contractual obligation;
an interface control component that is configured to generate an interface control and communicate the interface control to a client application from which the legal document or the online application is to be signed; and
a signature component configured to, in response to an activation of the interface control and based on an identity represented by the activated interface control, retrieve an electronic signature of the set of electronic signatures, and to sign the legal document or the online application with the electronic signature via the client application.

2. The system of claim 1, the computer-executable components further comprising:
a payment component configured to communicate a payment from a set of client accounts with purchasing data.

3. The system of claim 2, wherein the payment component is further configured to facilitate the payment in response to the activation of the interface control and in conjunction with a response of the signature component to sign with the electronic signature.

4. The system of claim 3, wherein the client application is a web browser and the interface control includes a graphical interface button.

5. The system of claim 3, wherein the activation of the interface control is initiated by a reception of a single input comprising a single touch input or a single click input.

6. The system of claim 1, wherein the server component is communicatively coupled to an account server and is further configured to communicate purchasing data to the account server for a transmission of funds from a set of client accounts, in response to the activation of the interface control at the client application.

7. The system of claim 1, the computer-executable components further comprising:
a signature creation component configured to create the electronic signature, store the electronic signature in the data store and edit the electronic signature according to a set of modification controls.

8. The system of claim 7, wherein the set of modification controls include at least one of an alteration control that alters a background appearance of the electronic signature based on reception of an alteration input, a combination control that combines the electronic signature stored with an additional digital mark, a time stamp control that time stamps the electronic signature in response to a retrieval of the electronic signature from the data store, a color control that selects a color for the electronic signature or a visibility control that selects a degree to which the electronic signature is visible.

9. The system of claim 7, wherein the signature creation component is configured to create the electronic signature according to at least one of a touch screen input, a digital ink gesture, or a handwritten stylus input received.

10. The system of claim 1, wherein the set of electronic signatures correspond respectively to a set of client accounts to facilitate payment of a transaction in connection with the legal document or the online application.

11. A method, comprising:
receiving, by a server component including at least one processor, a set of electronic signatures in connection with a legal document or an online application in an approval process of a contractual obligation;
generating an interface control to a client application from which the legal document or the online application is to be signed; and
communicating an electronic signature from the set of electronic signatures in response to receiving an activation of the interface control.

12. The method of claim 11, further comprising:
signing the legal document or the online application with the electronic signature of the set of electronic signatures via the client application in response to determining the interface control has been activated.

13. The method of claim 12, further comprising:
communicating a payment from a set of client accounts in response to the activation of the interface control.

14. The method of claim 13, further comprising:
receiving the activation of the interface control that includes a single click input or a single touch input of the interface control.

15. The method of claim 14, wherein the processing the payment, the communicating the electronic signature and the signing are simultaneously performed in response to the activation of the interface control.

16. The method of claim 11, wherein the generating the interface control includes generating a graphical interface button.

17. The method of claim 11, further comprising:
processing at least part of the legal document or the online application based on the electronic signature and a payment including communicating payment data to an account server for transmission of funds from a set of client accounts, in response to the activation of the interface control.

18. The method of claim 11, further comprising:
creating the electronic signature based on a set of modification controls that includes at least one of an alteration control that alters a background appearance of the electronic signature based on reception of an alteration input, a combination control that combines the electronic signature stored with an additional digital mark, a time stamp control that time stamps the electronic signature in response to a retrieval of the electronic signature from a client data store, a color control that selects a color for the electronic signature or a visibility control that selects whether the electronic signature is visible.

19. The method of claim 11, further comprising at least one of:
populating a transaction field of a networked application with payment data in response to the activation of the interface control;
populating an online application field or a legal document field of the networked application with the electronic signature in response to the activation of the interface control; or
populating a different online application field or a different document field of the networked application with identify data that includes personal data comprising name and contact information.

20. A computer readable storage medium comprising computer executable instructions that, in response to execution, cause a computing system including at least one processor to perform operations, comprising:
receiving, by a server component, an activation input of an interface control; and
communicating an electronic signature to a legal document or an online application for approval of a contractual obligation;
wherein the electronic signature corresponds to a unique identity and is created by a set of modification control inputs.

21. The computer readable storage medium of claim 20, wherein the creating the electronic signature includes creating the electronic signature
creating the electronic signature based on the set of modification control inputs that include at least one of an alteration control input that alters a background appearance of the electronic signature, a combination control input that combines the electronic signature stored with an additional digital mark, a time stamp input control that time stamps the electronic signature in response to a retrieval of the electronic signature from a client data store, a color control input that selects a color for the electronic signature or a visibility control input that selects whether the electronic signature is visible.

22. The computer readable storage medium of claim 20, wherein the creating the electronic signature includes creating the electronic signature based on at least one of the set of modification control inputs received including a touch screen input, a digital ink gesture input, or a handwritten stylus input.

23. The computer readable storage medium of claim 20, the operations further including:
generating the interface control to a web browser; and
communicating and signing the online application or the legal document with the electronic signature via the web browser in response to the activation input of the interface control.

24. The computer readable storage medium of claim 20, the operations further including:
processing a payment from a set of client accounts in response to the receiving of the activation input to the interface control.

25. The computer readable storage medium of claim 20, the operations further including:
populating a transaction field of a client application with payment data in response to the receiving of the activation input to the interface control; and
populating an online application field or legal document field of the client application with the electronic signature in response to the receiving of the activation input to the interface control.

26. A system comprising:
means for creating an electronic signature by a set of modification control inputs received via a client application;
means for receiving an activation input from an interface control via the client application; and
means for communicating the electronic signature to a legal document or an online application for approval for a contractual obligation.

27. The system of claim 26, further comprising:
means for processing a payment from a set of client accounts in response to the receiving of the activation input by the means for receiving.

28. The system of claim 26, wherein the set of modification control inputs received by the means for creating includes at least one of a touch screen input, a digital ink gesture, or a handwritten stylus input.

29. A mobile apparatus comprising:
a memory storing computer-executable instructions; and
a processor, communicatively coupled to the memory, configured to facilitate execution of the computer-executable instructions to at least:
communicate an electronic signature in response to receiving an activation of an interface control to a legal document, or an online application in an approval process of a contractual obligation; and
communicate a payment from a client account in response to the activation of the interface control.

30. The mobile apparatus of claim 29, wherein the electronic signature is a hand-written digital ink signature.

31. The mobile apparatus of claim 29, wherein the processor is further configured to facilitate execution of the computer-executable instructions to:
receive an electronic signature in connection with a legal document or an online application in an approval process of a contractual obligation; and
generating the interface control in a client application from which the legal document or the online application is to be signed and paid for.
